(19) United States
(12) Patent Application Publication
(10) Pub. No.: US 2020/0283151 A1
(43) Pub. Date: Sep. 10, 2020

(54) TIME OF DAY SIMULATION SYSTEM

(71) Applicant: GENTEX CORPORATION, Zeeland, MI (US)

(72) Inventor: Kevin J. Key, Holland, MI (US)

(73) Assignee: GENTEX CORPORATION, Zeeland, MI (US)

(21) Appl. No.: 16/295,345

(22) Filed: Mar. 7, 2019

(51) Int. Cl. B64D 11/00; G02F 1/163; B64D 13/08; B64C 1/14

(52) U.S. Cl. CPC B64D 11/00; B64C 1/14; B64D 13/08; G02F 1/163

(57) ABSTRACT

A time of day simulation system for an aircraft comprising: a master controller operable to: receive departure data, the departure data corresponding to a local departure time and a departure location of the aircraft. Receive arrival data, the arrival data corresponding to a local arrival time and arrival location of the aircraft. Receive time of flight data, the time of flight data corresponding to a time of flight of the aircraft. Analyze the departure data, arrival data, and time of flight data to determine a time difference between the local departure time and local arrival time, based on the analyzed data, calculate a time of day simulation. A window controller in communication with the master controller operable to control a transmission level of one or more electro-optic window assemblies. Wherein the master controller is further operable to, based on the identified time of day simulation, generate a control signal to adjust the transmittance level of the electro-optic window assemblies.

### FIELD OF THE INVENTION

The present disclosure generally relates to a time of day simulation system, and more particularly to a time of day simulation system for controlling one or more control systems in an aircraft.

### SUMMARY OF THE INVENTION

According to one aspect of the present disclosure, a time of day simulation system for an aircraft comprising: a master controller operable to: receive departure data, the departure data corresponding to a local departure time and a departure location of the aircraft. Receive arrival data, the arrival data corresponding to a local arrival time and arrival location of the aircraft. Receive time of flight data, the time of flight data corresponding to a time of flight of the aircraft. Analyze the departure data, arrival data, and time of flight data to determine a time difference between the local departure time and local arrival time, based on the analyzed data, calculate a time of day simulation. A window controller in communication with the master controller operable to control a transmission level of one or more electro-optic window assemblies. Wherein the master controller is further operable to, based on the identified time of day simulation, generate a control signal to adjust the transmittance level of the electro-optic window assemblies.

According to another embodiment of the present disclosure, a method for a time of day simulation system for an aircraft comprising: receiving departure data corresponding to a local departure time and a departure location of the aircraft. Receiving arrival data corresponding to a local arrival time and arrival location of the aircraft. Receiving time of flight data, the time of flight data corresponding to a time of flight of the aircraft. Analyzing the departure data, arrival data, and time of flight data to determine a time difference between the local departure time and local arrival time. Determining, based on the analyzed data a time of day simulation. Controlling a transmittance level of at least one electro-optic window in correlation with the time of day simulation.

These and other features, advantages, and objects of the present disclosure will be further understood and appreciated by those skilled in the art by reference to the following specification, claims, and appended drawings.

### BRIEF DESCRIPTION OF THE DRAWINGS

The present disclosure will become more fully understood from the detailed description and the accompanying drawings, wherein:

FIG. 1 is a top elevational view of one embodiment of a time of day simulation system of the present disclosure;

FIGS. 2A and 2B are exemplary tables for a time of day simulation system of the present disclosure;

FIG. 3 is an electrical diagram in block form of a time of day simulation system of FIG. 1;

FIG. 4 is a flow chart of a time of day simulation system of FIG. 1; and

FIG. 5 are window assemblies for a time of day simulation system of the present disclosure.

### BACKGROUND OF THE INVENTION

Jet lag is a common outcome of air travel when a traveler crosses over two or more time zones. While various activities in airports may help reduce jet lag between connecting flights (e.g. walking, drinking water), no systematic process currently exists to help a traveler reduce jet lag over the course of the flight. Jet lag, also called desynchronosis and flight fatigue, is a temporary disorder that causes fatigue, insomnia, and other symptoms as a result of air travel across time zones. It is considered a circadian rhythm sleep disorder, which is a disruption of the internal body clock.

### DETAILED DESCRIPTION OF THE EMBODIMENTS

The present illustrated embodiments reside primarily in combinations of method steps and apparatus components related to a time of day simulation system for an aircraft. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

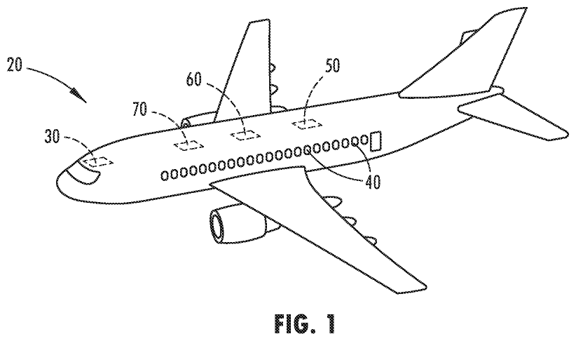

FIG. 1 shows a time of day simulation system 10 for an airplane 20. System 10 may include a master controller 30 in communication with one or more sub systems of aircraft 20. One sub system may include one or more electro-optic windows 40, having a transmittance level that is variable in response to electrical signals applied thereto. Another sub system may include a lighting control system 50. Lighting control system 50 may control the interior cabin lights throughout aircraft 20. Master controller 30 may also be in communication with an audio sub system 60, which may comprise a speaker system within aircraft 20. Another sub system may be a temperature control system 70 that controls the thermostat and temperature within airplane 20. Time of day simulation system 10 may be used to adjust one or more sub systems throughout aircraft 20. Time of day simulation system 10 is used to stimulate or trick the passenger's senses into perceiving a time of day, different from an actual time of day, throughout the period of the flight. Time of day simulation system 10 can speed or up slow down the perceived time. This may be done by adjusting cabin sub systems in order to reduce or eliminate jet lag and allow a passenger's circadian rhythm to be synchronized with the destination of aircraft 20.

Master controller 30 may represent or include any form of a controller component, including general purpose computers, dedicated microprocessors, or other processing devices capable of processing and/or controlling electronic information. Examples of master controller 30 may include digital signal processors (DSPs), application-specific integrated circuits (ASICs), field-programmable gate arrays (FPGAs), and any other suitable specific or general-purpose controllers. Although FIG. 1 illustrates a particular embodiment of system 10 that includes a single master controller, system 10 may, in general, include any suitable number of controllers 30.

System 10 may also include one or more slave controllers. The slave controllers, for example, may control a single electro-optic window 40. Each slave controller may be in wireless or wired communication with master controller 30. Master controller 30 may be configured to monitor signals transmitted from the slave controllers and/or to transmit signals to the slave controllers. Both the slave controllers and the master controller 30 should include processing circuitry, including programmable logic, memory, and interface circuitry, to permit them both to generate, send, receive, and decode transmitted signals. Master controller 30 may be in communication with one or more sub systems of aircraft 20. One sub system may include a plurality of electro-optic windows 40, each having a transmittance level that is variable in response to electrical signals applied thereto. Another sub system may include a lighting control system 50, this system may control the interior cabin lights throughout aircraft 20. Master controller 30 may also be in communication with an audio sub system 60, which may comprise a speaker system within aircraft 20. Another sub system may be a temperature control system 70 that controls the thermostat and temperature throughout airplane 20.

Further, master controller 30 may be operable to receive data corresponding to a departure time and a departure location of aircraft 20 and/or receive data corresponding to an arrival time and an arrival location of aircraft 20. This data may be manually entered by the pilot or may be received from one or more computer software systems that an aircraft may be equipped with. The data may also be provided by a portable electronic device. Master controller 30 may analyze the data to determine a time of flight and time difference between the departure location and destination and may use the data to calculate a time of day simulation sequence. The time of day simulation sequence can be recalculated and updated throughout the flight to account for different environmental conditions. For example, the plane may have a tailwind which will decrease the time of flight or the aircraft may have a headwind which may cause the time of flight to increase. Master controller 30 may be in communication with various sub systems of aircraft 20. For example, master controller 30 may be in communication with a window controller used to control electro-optic window 40 and based on the identified time of day simulation sequence, master controller 30 may generate a control signal to adjust the transmittance level of one or more the electro-optic windows 40.

A user, such as, e.g., a pilot, may operate the master controller 30, which may have overriding capabilities during take-off and landing. Master controller 30 can control all applicable aircraft sub systems and may be set or adjusted to any settings inputted by master controller 30. For example, master controller 30 may control electro-optic windows 40 to return to a lightened state. In another instance, master controller 30 may be configured to maintain the override transmittance state for a predetermined period or until the pilot or flight attendant removes the override. Thereafter, passengers seated next to one of windows 40 will have the option to change its transmittance state to one based on a passenger's preference.

Electro-optic window 40 may be a single electro optic window or may be a plurality of windows. Each electro-optic window 40 may have a variable transmittance window control system or slave control system that is electrically coupled to electro-optic windows 40 for controlling the transmittance state of windows 40. The variable transmittance window control system may comprise a master controller 30 in communication with a plurality of electro-optic windows 40. Each window 40 may have a slave controller to adjust the transmission level of the respective window 40. Each window 40 may also include a user input mechanism for providing a user input to the slave controller to change the transmittance state of the associated window 40. Master controller 30 maybe configured to issue override signals to direct the slave controller of each window 40 to change the transmittance state of the associated window 40. The transmittance state is selected by the override signal sent by the master controller 30. Override signals issued to the slave controller may include signals to cause one, some, or all of the electro-optic windows 40 to change to an override transmittance state. In so doing, the one or more electro-optic windows 40 may darken, lighten, go to the darkest state, go to the lightest state, or go to a predetermined intermediate transmittance state in an incremental manner. Further, master controller 30 may direct all slave controllers to alter the states of their electro-optic window 40 at the same time, one at a time, or in groups, in order to minimize system power loading, to optimize passenger comfort, or to control lighting levels, in correlation with time of day simulation system 10.

Further, electro-optic window 40 may include an element comprising a first substantially transparent substrate and a second substantially transparent substrate in a spaced apart relationship. A seal is positioned therebetween near the perimeter to define a chamber containing an electrochromic medium. Electro-optic window 40 may include a substantially transparent display, such as an organic light emitting diode (OLED) display. Such OLEDs can be constructed such that they are thin transparent displays that could be mounted inside the chamber in which the electrochromic medium is maintained. Because OLED can be transparent, it would not interfere with the image viewed by the passenger of the aircraft. Additionally, by providing OLED inside the chamber between the substrates, display is protected from any adverse environmental effects. Thus, such an arrangement is particularly desirable when mounting a display device in an aircraft window assembly. The transparent display may be used to display a scene on the aircraft window. For example, if it is a nighttime condition outside of the aircraft, the display can be illuminated and show an image or video of a sunny day with clouds to simulate a daytime condition.

Lighting control system 50 may control the lighting throughout the cabin of aircraft 20. Lighting control system 50 may be in communication with master controller 30 to adjust cabin lights of aircraft 20. In normal flight, a passenger has the ability to adjust a light level proximate to his or her seat. For example, a passenger may activate a reading light to allow the passenger to read throughout the flight. Master controller 30 may be in communication with lighting control system 50 that may adjust the light levels at each individual seat. Lighting control system 50 may include one or more slave controllers, each associated with a passenger seating area. Each seat may also include a user input mechanism for providing a user input to the lighting control system 50, to change the lighting levels to the user preference at each seat. Master controller 30 may be configured to issue override signals to direct the slave controller of each seat to change the lighting levels at each seat. The lighting level is selected by the override signal sent by the master controller 30. Override signals issued to the slave controllers may include signals to cause one, some, or all of the lights to change to an override lighting level. In so doing, the one or more lights may darken, lighten, go to the darkest state, go to the lightest state, or go to a predetermined intermediate lighting level in an incremental manner. Further, master controller 30 may direct all slave controllers to alter the states of their lights at the same time, one at a time, or in groups, in order to minimize system power loading, to optimize passenger comfort, or to control lighting levels throughout the aircraft cabin. Lighting control system 50 may also provide different lighting colors throughout the aircraft cabin to simulate a time of day. For example, in the morning the cabin lights may be illuminated orange or yellow to simulate the sunlight or could be illuminated a purple or blue color at night time to simulate a night sky.

Audio sub system 60 may incorporate one or more speakers throughout aircraft 20. Audio sub system 60 may be in communication with master controller 30 to adjust the audio of one or more speakers throughout the cabin of aircraft 20. In normal flight, audio sub system 60 may be used for passenger briefings from the flight attendants or pilot and/or used to notify the passengers of updates throughout the flight. Sound effects that correlate with a time of day, such as crickets at night or birds chirping in the morning or any other sound effect, can be played over audio sub system 60 to give the passengers a sense of a specific time of day.

Temperature control system 70 may be used to control the thermostat and temperature throughout airplane 20. Temperature control system 70 may be in communication with master controller 30. Temperature control system 70 may be used to simulate a temperature that can be correlated with a time of day throughout the flight. For example, as time of day simulation system 10 simulates a night time condition, the temperature may be reduced throughout the cabin of aircraft 20. If a day time condition is being simulated, the temperature may be increased throughout the flight to simulate a sunrise and the continued warming of the earth that occurs throughout the day.

In operation, time of day simulation system 10 may use one or more of the sub systems described above to simulate one or more time of day condition in aircraft 20. Time of day simulation system 10 may be present throughout the entire cabin of the aircraft 20 or may be limited to a section of aircraft 20. For example, master controller 30 may dim the electro-optic windows 40, dim the lighting control system 50, play appropriate sounds associated with a time of day throughout audio control system 60 and decrease the temperature of temperature control system 70, in order to simulate a night time condition. Master controller 30 can also simulate a day time condition, for example, by clearing electro-optic windows 40, illuminating the transparent display, raising the lighting control system levels 50, playing a sound of throughout audio system 60 and raising the temperature of temperature system 70, or by any combination thereof.

Once a destination of aircraft 20 is determined, time of day simulation system 10 may perform a sequence of operation to adjust a perceived time of day based on a time of day of the destination. The time of day simulation system 10 may alter the perceived time immediately once passengers enter aircraft 20. For example, it is currently day time where aircraft 20 is departing from but it is night time where the destination is. Accordingly, time of day simulation system 10 may adjust a perceived time of day to a night time condition. This will help to reduce jet lag because the passenger's body will have the course of the flight to adjust to the time of day of the destination. Time of day simulation system 10 may also alter the perceived time throughout the flight to continuously match the destination. For example, if sunrise may occur at the destination during the flight, the aircraft 20 sub-systems can be altered to simulate a sunrise in aircraft 20.

Technical advantages of the present disclosure may include reducing the effects of jet lag. Jet lag is a common outcome of air travel when a traveler crosses over two or more time zones. While various activities in airports may help reduce jet lag between connecting flights (e.g. walking, drinking water), no systematic process currently exists to help a traveler reduce jet lag over the course of the flight. Jet lag, also called desynchronosis and flight fatigue, is a temporary disorder that causes fatigue, insomnia, and other symptoms as a result of air travel across time zones. It is considered a circadian rhythm sleep disorder, which is a disruption of the internal body clock.

Time of day simulation system 10 automatically controls one or more aircraft cabin systems such as electro-optic dimming windows (EDW), lighting, sound and temperature in order to trick the passenger's senses into perceiving the necessary time of day throughout the period of the flight. Upon arrival, the passenger's circadian rhythm may be synchronized with the destination.

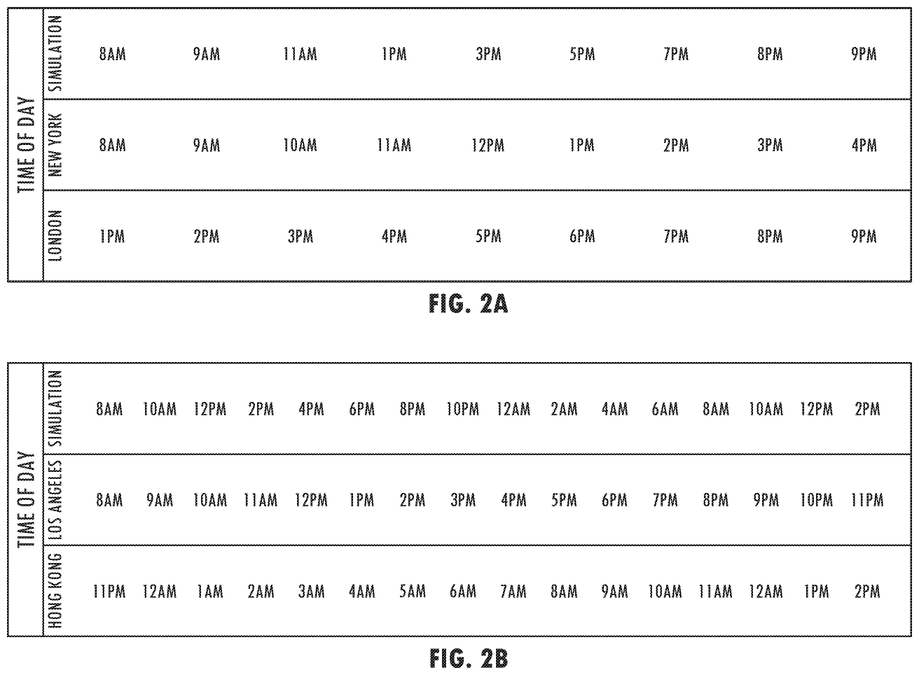

Time of day simulation system 10 may also gradually change the simulated time of day from the departure location to the destination. The following example, as seen in FIG. 2A, illustrates a simulated 13-hour perceived time change over the course of an 8-hour flight from New York to London. If aircraft 20 departs from New York at 8 AM, the corresponding time in London would be 1 PM. Once aircraft 20 arrives in London it will be 9 PM, London time, which is a 13-hour time difference from when the plane departed in New York time. Time of day simulation system 10 may use an algorithm that calculates a difference between a local departure time and a local arrival time divided by the time of the flight. In this example, a 13-hour time difference exists between the departure time of the flight to the arrival time of the flight. This is measured by the difference between a nominal local time from the start of the flight and the nominal local time at the destination at the end of the flight. However, only 8-hours of actual time elapses over the flight. The algorithm will divide the local time difference over the time of the flight, or 13 hours divided by 8 hours. Accordingly, time of day simulation system 10 may simulate 1.6 hours of time change for every hour in flight.

Another example, as seen in FIG. 2B, may be a flight from Los Angeles to Hong Kong. Aircraft 20 departing Los Angeles at 8 AM local time and will depart at 11 PM Hong Kong local time. This example illustrates a simulated 30-hour time change over the course of a 15-hour flight. The algorithm will divide the local time difference over the time of the flight, or 30 hours divided by 15 hours. Time of day simulation system 10 will need to simulate 2 hours of time change for every hour aircraft 20 is in flight.

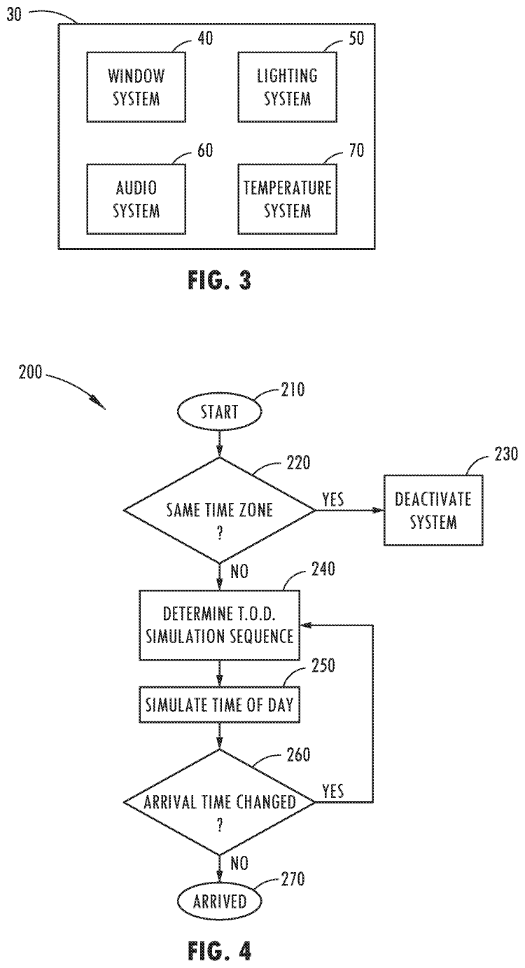

FIG. 3 is a block diagram illustrating in greater detail the contents and operation of a particular embodiment of master controller 30 shown in FIG. 1. in communication with one or more sub systems of aircraft 20. One sub system may include one or more electro-optic windows 40 having a transmittance level that is variable in response to electrical signals applied thereto. Electro-optic window 40, may be a single electro optic window or may be a plurality of windows. Each electro-optic window 40 may have a variable transmittance window control system or slave control system, that is electrically coupled to electro-optic windows 40 for controlling the transmittance state of windows 40. The variable transmittance window control system may include a master controller 30 in communication with a plurality of electro-optic windows 40. Each window 40 may have a slave controller to adjust the transmission level of that individual window 40. Each window 40 may also includes a user input mechanism for providing a user input to the slave controller to change the transmittance state of the associated window 40. Master controller 30 is configured to issue override signals to direct the slave controller of each window 40 to change the transmittance state of the associated window 40. The transmittance state is selected by the override signal sent by the master controller 30. Override signals issued to the slave controller may include signals to cause one, some, or all of the electro-optic windows 40 to change to an override transmittance state. In doing so, the one or more electro-optic windows 40 may darken, lighten, go to the darkest state, go to the lightest state, or go to a predetermined intermediate transmittance state in an incremental manner. Further, master controller 30 may direct all slave controllers to alter the states of their electro-optic window 40 at the same time, one at a time, or in groups, in order to minimize system power loading, to optimize passenger comfort or to control lighting levels, in correlation with time of day simulation system 10, due to light entering from outside of the aircraft cabin.

Another sub system controlled by master controller 30 may include a lighting control system 50. Lighting control system 50 may control the lighting throughout the cabin of aircraft 20. Lighting control system 50 may be in communication with master controller 30 to adjust all of the cabin lights of aircraft 20. In normal flight, a passenger has the ability to adjust the light levels above their seat, such as, activating a reading light to allow the passenger to read throughout the flight. Master controller 30 may be in communication with a slave controller that may adjust the light levels at each individual seat. Each seat may also include a user input mechanism for providing a user input to the lighting slave controller to change the lighting levels to the user preference at each seat. Master controller 30 is configured to issue override signals to direct the slave controller of each seat to change the lighting levels at each seat. The lighting level is selected by the override signal sent by the master controller 30. Override signals issued to the slave controllers may include signals to cause one, some, or all of the lights to change to an override lighting level. In doing so, the one or more lights may darken, lighten, go to the darkest state, go to the lightest state, or go to a predetermined intermediate lighting level in an incremental manner. Further, master controller 30 may direct all slave controllers to alter the states of their lights at the same time, one at a time, or in groups, in order to minimize system power loading, to optimize passenger comfort or to control lighting levels throughout the aircraft cabin. Lighting control system 50 may also provide different lighting colors throughout the aircraft cabin to simulate a time of day.

Master controller 30 may also be in communication with an audio sub system 60. Audio sub system 60 may incorporate one or more speakers throughout aircraft 20. Audio sub system 60 may be in communication with master controller 30 to adjust the audio of one or more speakers throughout the cabin of aircraft 20. In normal flight, audio sub system 60 may be used for passenger briefings from the flight attendants or pilot and/or used to notify the passengers of updates throughout the flight. Sound effects that correlate with a time of day, such as crickets at night or birds chirping in the morning or any other sound effect, can be played over audio sub system 60 to give the passengers a sense of a specific time of day.

Further, master controller 30 may be in communication with a temperature control system 70. Temperature control system 70 may be used to control the thermostat and temperature throughout airplane 20. Temperature control system 70 may be used to simulate a temperature that can be correlated with a time of day throughout the flight. For example, as time of day simulation system 10 simulates a night time condition, the temperature may be reduced throughout the cabin of aircraft 20. If a day time condition is being simulated, the temperature may be increased throughout the flight to simulate a sunrise and the continued warming of the earth that occurs throughout the day. Time of day simulation system 10 may be used to adjust one or more sub systems throughout aircraft 20. Time of day simulation system 10 is used to stimulate a different time of day than the actual time of day, thereby tricking the passenger's senses into perceiving the necessary time of day throughout the period of the flight. Time of day simulation system 10 can speed or up slow down the perceived time. This may be done by adjusting cabin sub systems in order to reduce or eliminate jet lag and allow a passenger's circadian rhythm to be synchronized with the destination.

FIG. 4 is a block diagram representing the general algorithmic outline of a time of day simulation system 200 for an aircraft. The steps in FIG. 4 may be combined, modified, or deleted where appropriate, and additional steps may also be added to those shown. Additionally, the steps may be performed in any suitable order without departing from the scope of the disclosure.

Operation, in the illustrated example, begins at step 210. The system is initiated once the pilots, flight crew and/or passengers board the plane 210. The system may also be initiated automatically once the master power switch to the aircraft has been turned on and the system begins to operate. A flight path or plan may be entered into the airplane or may be communicated to the airplane from a mobile communication device (such as a tablet or smart phone) using short range communication. Once a flight plan has been entered, an algorithm may then be determined for the time of day simulation system. For example, time of day simulation system 200 may receive or determine depature data, arrival data, and/or time of flight data. The algorithm is determined using information such as the time and location of departure and the time and location of the destination. The location of the aircraft may be determined by a global positioning satellite (GPS) or by other means known in the art. The algorithm may also take into account the current wind conditions, such as a headwind or a tailwind for the flight and can use that to adjust the estimated arrival and flight time. Other factors may be taken into account with the algorithm, such as time of year for each location (examples: season or sunrise and sunset times for the calendar day) or weather conditions (examples: cloudy, raining or snowing).

In step 220, time of day simulation system determines if the departure time and the arrival time of the flight are in the same time zone. If the destination is in the same time zone as the departure, the system may be deactivated in step 230 or no changes will be performed to the cabin environment of the aircraft by the time of day simulation system 200. If the destination is in a different time zone it will proceed to step 240.

In step 240 the pre-determined algorithm is selected automatically or by a user interface to adjust cabin features of the aircraft. Once the passengers are all boarded on the plane and the departure has begun, the time of day simulation system may begin to operate once the algorithm is selected. Time of day simulation system 10 may use an algorithm that calculates the difference between a local departure time and a local arrival time divided by the time of the flight. For example, a 13-hour time difference exists between the departure time of the flight to the arrival time of the flight. The time is measured by the nominal time of the departure location and the nominal time of the local time of the arrival location. However, only 8-hours of actual time elapses over the flight. The algorithm will divide the local time difference over the time of the flight, or 13-hours divided by 8-hours. Accordingly, time of day simulation system 10 may simulate 1.6 hours of change for every hour in flight.

In step 250, The master controller begins to adjust one or more sub system settings of the aircraft in order to simulate a time of day. For example, at the destination it may be day time, whereas the current condition of the departure is night, the controller may illuminate the level of a transparent display that is in optical communication with the windows of the aircraft. The transparent display may illuminate at different levels to simulate different times of the day or may display a scene to simulate a different time of day (example: can display a sunrise in the morning or a sunset in the evening). If the time of day at the destination is currently night time and the departure is in the day time, the controller can dim an electro-optic window to various darkness's to simulate the time of day of the destination. The transparent display may also be used to display a scene that represents night time (example: a moon, dark sky with clouds or stars).

Master controller may also activate various other systems located throughout the aircraft in accordance with the time of day simulation system. A dynamic lighting system can be used inside of the cabin of the aircraft, to again simulate the time of day. The master controller may be configured to control the intensity, color, wavelength or various other features of a dynamic lighting system based on a pre-determined algorithm or a user input. Further, the time of day simulation system 200 may include a speaker or audio system throughout the cabin of the aircraft. The audio system may include at least one speaker. The master controller may be in communication with the at least one speaker and may be configured to provide audio queues associated with the simulated time of day (example: birds chirping in the morning or crickets chirping at night). Time of day simulation system 200 may also include a temperature control system. Master controller may be in communication with the temperature control system and may be configured to adjust the temperature of the cabin of the aircraft in correlation with the temperature of the destination or the time of day.

Master controller may operate all of these sub systems in combination or individually to achieve the desired time of day simulation. Accordingly, the effects of jet lag may be reduced, and a passenger's body may be tricked to be on the same circadian rhythm as a destination. Once the passengers reach the destination, time of day simulation system 200 will have at least partially transitioned the circadian rhythm of the occupants to match the time of day of the destination.

In step 260, the aircraft is midflight. The time of day simulation system rechecks the estimated arrival time correlating with any changes throughout the course of the flight. For example, if a headwind has developed and the arrival time will be later than originally planned, a new algorithm will be used to decrease the rate of change of the time of day simulation system. If a tailwind has developed and now the expected arrival time is earlier than originally calculated, the time of day simulation system can speed up the rate of change of the cabin environment by adjusting or altering the cabin sub systems. Step 260 can happen multiple times throughout a flight. The system continues to monitor different flight conditions to ensure the proper rate of change is being implemented. Weather conditions and emergency landings can also affect the arrival times of the aircraft. If the arrival destination is changed due to weather, the time of day simulation system automatically adjusts the algorithm and change rate to simulate the new destination and/or arrival time. If an emergency landing is needed, the time of day simulation system may then be deactivated.

In step 270, the aircraft has arrived at its destination Accordingly, the effects ofjet lag may be reduced, and a passenger's body may be tricked to be on the same circadian rhythm as the destination. Now that the passengers have reached the destination, time of day simulation system 200 will have at least partially transitioned the circadian rhythm of the passengers to match the time of day of the destination.

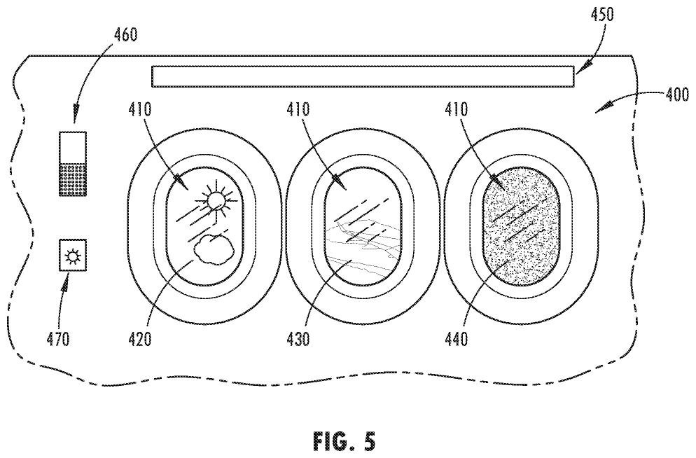

Referring now to FIG. 5, a of a time of day simulation system 400 for an aircraft may include one or more windows 410 incorporating an electro-optic variable transition window in optical communication with a transparent display. The transparent display may correspond to a waveguide display or other emissive display device. A master controller is used in communication with the display system and may be operable to change the operating states of the display from a display state, to a transparent state. In the display state, a viewing surface of the display system, may be configured to project an image outward toward a passenger 420 (example: display an image of the sun shining and clouds in the sky when really the current condition is night where the aircraft is traveling). The image may be pre-programmed scenes to depict a simulated time of day such as a sunrise or day time conditions. The displayed image may be a still image or may be a video that gives the effect of looking out of a window in a moving aircraft. In the transparent state, the display system may be substantially transparent allowing a passenger to view the scene external of the aircraft 430. The master controller is also in communication with the electro-optic variable transmission portion of the window and may be configured to selectively control the transmittance of the electro-optic window to control a contrast between the window and the display assembly. In this way, the controller may control the transmittance of the electro-optic window to provide a contrast to improve a visibility of the image data and/or video displayed on the viewing surface. The transmittance of the electro-optic window may be adjusted for a substantially clear transmittance allowing a passenger to view the scene outside of the window and/or may be dimmed to a very dark transmittance giving the illusion of a night time condition outside of aircraft as seen at reference identifier 440.

Further, time of day simulation system 400 may also activate various other systems located throughout the aircraft in accordance with the time of day simulation system. A dynamic lighting system 450 can be used inside of the cabin of the aircraft, to again simulate the time of day. The master controller may be configured to control the intensity, color, wavelength or various other features of a dynamic lighting system based on a pre-determined algorithm or a user input. Further, the time of day simulation system 400 may include a speaker or audio system 460 throughout the cabin of the aircraft. Audio system 460 may include at least one speaker. The master controller may be in communication with the at least one speaker and may be configured to provide audio queues associated with the simulated time of day (example: birds chirping in the morning or crickets chirping at night). Time of day simulation system 400 may also include a temperature control system 470. Master controller may be in communication with temperature control system 470 and may be configured to adjust the temperature of the cabin of the aircraft in correlation with the temperature of the destination or the time of day.

Master controller may operate all of these sub systems in combination or individually to achieve the desired time of day simulation. The goal of this system is to reduce the effects of jet lag and to trick or manipulate the body to be on the same circadian rhythm as your destination or to slowly adjust the setting of the time of day simulation system 400 to ease the effects of jet lag. Once the passengers reach the destination, time of day simulation system 400 will have transitioned the circadian rhythm of the occupants to match the time of day of the destination.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. A time of day simulation system for an aircraft comprising:
a master controller operable to:
receive departure data, the departure data corresponding to a local departure time and a departure location of the aircraft;
receive arrival data, the arrival data corresponding to a local arrival time and arrival location of the aircraft;
receive time of flight data, the time of flight data corresponding to a time of flight of the aircraft;
analyze the departure data, arrival data, and time of flight data to determine a time difference between the local departure time and local arrival time;
based on the analyzed data, calculate a time of day simulation; and
a window controller in communication with the master controller operable to control a transmission level of one or more electro-optic window assemblies;
wherein the master controller is further operable to, based on the identified time of day simulation, generate a control signal to adjust the transmittance level of the electro-optic window assemblies.

2. The system of claim 1, wherein the master controller is configured to at least one of darken the electro-optic window to simulate a night condition or illuminate the transparent display to simulate a day time condition in correlation with the destination of the aircraft.

3. The system of claim 2, wherein the destination of the aircraft is determined by a global positioning satellite (GPS).

4. The system of claim 1, wherein the master controller calculates a time of day simulation algorithm by dividing the time difference by the time of flight.

5. The system of claim 4, wherein the master controller is further configured to control a lighting system inside of the aircraft, the master controller is configured to control at least one of the intensity, color or wavelength of the dynamic lighting system.

6. The system of claim 1, wherein the master controller is further configured to calculate a second algorithm based on a change in the time of flight data.

7. The system of claim 6, wherein the second algorithm comprises increasing the rate of change of the time of day simulation system.

8. The system of claim 6, wherein the second algorithm comprises decreasing the rate of change of the time of day simulation system.

9. The system of claim 1, wherein the master controller is in communication with at least one speaker and is configured to provide audio queues associated with the simulated time of day.

10. The system of claim 1 further comprising an automatic temperature control system in communication with the master controller, wherein the master controller is configured to automatically adjust the temperature of the aircraft in correlation with the aircraft destination.

11. The system of claim 1, wherein the master controller selects a pre-determined time of day simulation setting based upon the time difference from departure time to arrival time divided by the time of the flight.

12. A method for a time of day simulation system for an aircraft comprising:
receiving departure data corresponding to a local departure time and a departure location of the aircraft;
receiving arrival data corresponding to a local arrival time and arrival location of the aircraft;
receiving time of flight data, the time of flight data corresponding to a time of flight of the aircraft;
analyzing the departure data, arrival data, and time of flight data to determine a time difference between the local departure time and local arrival time;
determining, based on the analyzed data a time of day simulation; and
controlling a transmittance level of at least one electro-optic window in correlation with the time of day simulation.

13. The method of claim 12 further controlling a transmittance level of at least one electro-optic window to simulate a night time condition.

14. The method of claim 12 further illuminating, with the master controller a transparent display in optical communication with the electro-optic window to simulate a day time condition.

15. The method of claim 12 further comprising controlling, with the master controller, a lighting control system, wherein the master controller is configured to control at least one of intensity, color or wavelength of the lighting control system to simulate a time of day.

16. The method of claim 12 further comprising controlling, with the master controller, an audio control system configured to provide audio queues associated with a simulated time of day.

17. The method of claim 12 further comprising adjusting, with the master controller, a temperature of the aircraft in correlation with the aircraft destination.

18. The method of claim 12 further calculating adjusting, with the master controller, the difference between a local departure time and a local arrival time divided by the time of the flight to determine a rate of change, wherein the algorithm is used to adjust the time of day simulation system.

19. The method of claim 12 further controlling, with the master controller, at least one of a lighting control system, an audio control system, a temperature control system, or a combination thereof.

20. The method of claim 12 further calculating, with the master controller, a time of day simulation algorithm by dividing the time difference by the time of flight.
